(19) United States
(12) Patent Application Publication
(10) Pub. No.: US 2003/0005784 A1
(43) Pub. Date: Jan. 9, 2003

(54) Device for coupling one accessory with a main drive

(76) Inventors: Klaus-Peter Schnelle, Ditzingen (DE); Stefan Tumback, Stuttgart (DE)

Correspondence Address: Striker Striker & Stenby, 103 East Neck Road, Huntington, NY, 11743, US

(21) Appl. No.: 09/980,934

(22) PCT Filed: Apr. 9, 2001
(86) PCT No.: PCT/DE01/01374

(30) Foreign Application Priority Data
Apr. 7, 2000 (DE) 100 16 988.0

(51) Int. Cl. F02N 1/00

(52) U.S. Cl. 74/7 C

(57) ABSTRACT

An apparatus is proposed for coupling at least one secondary assembly (32), in particular a starter generator, to a primary assembly (20), in particular an internal combustion engine. The at least one secondary assembly (32) and the apparatus for coupling (26) are connected to each other by means of a transmission mechanism (27). The apparatus has an epicyclic gear (38) which connects the primary assembly (20) to the transmission mechanism (27) and the epicyclic gear (38) can be switched between two multiplications by means of a first coupling (53). The first coupling (53) is a free-wheel coupling and a ring gear (50) of the epicyclic gear (38) can be immobilized in at least one rotation direction by means of a second coupling (56).

### PRIOR ART

The invention relates to an apparatus for coupling at least one secondary assembly to a primary assembly, in particular for coupling a starter generator to an internal combustion engine, as generically defined by the preamble to the independent claim.

Apparatuses for coupling secondary assemblies to a primary assembly have already been disclosed by DE 196 13 291 A1. The known apparatus has an epicyclic gear with a sun wheel which is non-rotatably connected to a drive shaft. Planet wheels are situated around the sun wheel and their axles are connected to a pulley. The planet wheels roll against a ring gear which is connected to a coupling apparatus. This coupling apparatus has two switch positions; in a first switch position, the ring gear can be non-rotatably connected to the planet wheels. In a second switch position, the ring gear can be connected to a stationary frame by means of the coupling apparatus. The coupling apparatus can be switched by means of an electromagnet. In the first position, in which the electromagnet is not supplied with current, the ring gear is coupled to the planet wheels. In the second switch position, the ring gear is connected to the frame.

This apparatus has the disadvantage that the drive shaft of the internal combustion engine is always coupled to the belt drive. This is particularly disadvantageous if, a starter generator that is operated by the engine is to drive a secondary assembly via a shared belt drive when the engine is switched off. Another disadvantage of this known apparatus is that in order to adjust the multiplication of the epicyclic gear, in each instance, an active switch element is required, in this case a magnetic coupling. In addition, the apparatus must be adjusted from the outside. A further disadvantage is that a continuous supply of current is required in order to actively switch the magnetic coupling and as a result, additional energy must be expended.

### ADVANTAGES OF THE INVENTION

With the apparatus according to the invention, with the features of the independent claim, when there is a common belt drive shared by the starter generator, internal combustion engine, and another secondary assembly, it is possible to drive this secondary assembly even when the engine is switched off, without the transmission of moment to the engine and/or to the primary assembly. As a result, it is possible, for example, for a secondary assembly operated as a motor, e.g. the starter generator, to transmit a torque to an air conditioning compressor, for example, via the wheel of the apparatus according to the invention without thereby transmitting a moment to the primary assembly and/or its drive shaft. This is particularly advantageous if the primary assembly is switched off, i.e. its drive shaft is not turning. This is the case when it is necessary to continue to air condition a vehicle with a mechanically driven air conditioning compressor when a primary assembly of the vehicle is switched off.

Other advantageous embodiments of the apparatus according to the main claim are possible by means of the features disclosed in the dependent claims.

If the planet support is connected to a drive shaft of the internal combustion engine, then the multiplication of one is produced between the drive shaft and the wheel and/or the pulley, which is particularly advantageous if the drive shaft is driving a starter generator, which is operated as a generator, by means of the pulley.

On the other hand, a gear change of the epicyclic gear makes it possible with a starter generator, which is operated as a motor, to transmit a particularly high moment to the drive shaft.

If the ring gear is embodied as an intermediate ring, it is possible to dispose a second coupling on it, by means of which the intermediate ring assumes other functions.

Because the intermediate ring on the one hand represents a part of the first coupling and simultaneously represents a part of the epicyclic gear and on the other hand, is a part of a second coupling, it is possible to change the multiplication of the apparatus between the pulley and the drive shaft, depending on the moment action on the pulley.

Particularly when a driving torque is acting on the drive shaft and/or the crankshaft by means of the wheel and/or the pulley, there is a large degree of demultiplication so that the moment action on the drive shaft and/or the crankshaft is very high. However, if the drive shaft drives the starter generator, which is operating as a generator, by means of the pulley, then the starter generator is driven with the multiplication of one. It is consequently advantageous if the first coupling and the second coupling have the same locking directions.

It is advantageous if the second coupling can be switched independently of the first coupling since the couplings can thus be designed to be independent of each other.

If the rigid connection of the intermediary ring to a stationary part is cancelled by the disengagement of the second coupling, this has the advantage that when the primary assembly or the internal combustion engine is not being driven, i.e. when the planet support is not in motion, no moment is transmitted to the primary assembly by means of the wheel and/or the pulley and therefore by means of the sun wheel. The wheel and/or the pulley is then only used as a deflection roller. As a result, a mechanically driven air conditioning compressor can advantageously be driven even when the vehicle is not operating and the primary assembly and/or engine is not being driven.

Another advantage is that when the planet support is not turning and the sun wheel is turning, the rotating outer ring can be slowed by means of a brake. If the outer ring is braked when the wheel, i.e. the sun wheel, is being driven, then an angular momentum can be transmitted to the crankshaft and as a result, it is possible to start the engine by means of a so-called momentum start.

### DRAWINGS

The invention will be explained in detail below in several exemplary embodiments in conjunction with the associated drawings.

FIG. 1 shows a first arrangement including a primary assembly with the apparatus according to the invention and two secondary assemblies,

FIGS. 2, 3, and 4 show a first exemplary embodiment of the apparatus according to the invention,

FIGS. 5 and 6 show a second exemplary embodiment of the apparatus according to the invention,

FIGS. 7, 8, and 9 show a third exemplary embodiment,

FIG. 10 shows a fourth exemplary embodiment,

FIG. 11 shows a fifth exemplary embodiment,

FIG. 12 shows a longitudinal section through a sixth exemplary embodiment,

FIG. 13 shows the sixth exemplary embodiment in a cross section according to the line XIII-XIII in FIG. 12,

FIGS. 14 and 15 show a seventh exemplary embodiment,

FIGS. 16 and 16A show an eighth exemplary embodiment,

FIGS. 17 and 18 show a ninth exemplary embodiment,

FIGS. 19 and 19A show a last exemplary embodiment,

FIGS. 20A and 20B show details of the exemplary embodiment according to FIG. 19, and

FIG. 21 shows a second arrangement including a primary assembly with the apparatus according to the invention and two secondary assemblies.

a second arrangement including a primary assembly with the apparatus according to the invention and two secondary assemblies with a gearwheel drive.

### DESCRIPTION OF THE EXEMPLARY EMBODIMENTS

Parts which are identical or function in the same manner are provided with the same reference numerals.

FIG. 1 shows an apparatus including a primary assembly 20 in an embodiment as an internal combustion engine. The primary assembly 20 has a drive shaft 23, which is connected to an apparatus 26. By means of a transmission mechanism 27, the apparatus 26 is connected to a secondary assembly 32 that is embodied as a so-called starter generator. The transmission mechanism 27 is embodied as a traction-driven transmission mechanism. Furthermore, the traction mechanism 29 drives another secondary assembly in the form of an air conditioning compressor 35.

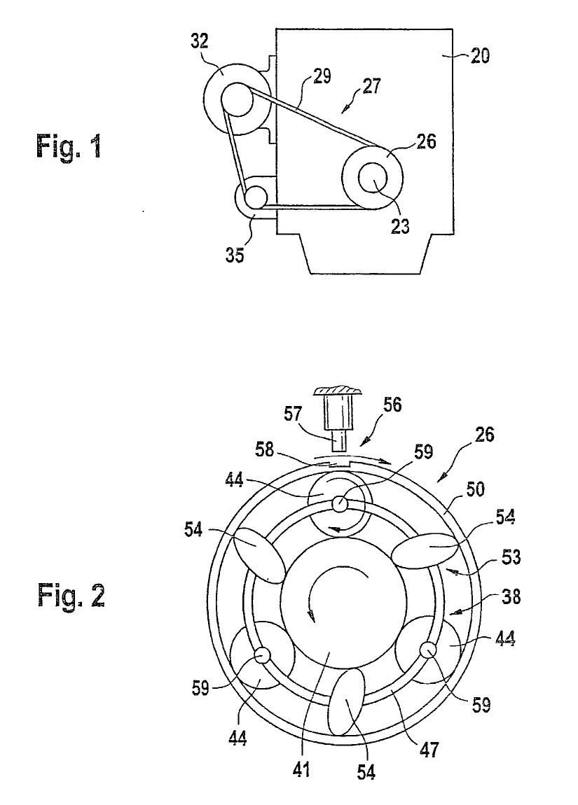

FIG. 2 shows a schematic view of the apparatus 26 in a first exemplary embodiment. The apparatus 26 has an epicyclic gear 38 with a sun wheel 41, planet wheels 44, a planet support 47, and a ring gear 50. The ring gear 50 can be coupled to the sun wheel 41 by means of a first coupling 53. The coupling 53 is embodied as a free-wheel. The coupling 53 permits a relative rotation of the sun wheel 41 in relation to the ring gear 50 in a first rotation direction, but the coupling 53 locks in a second rotation direction, a relative rotation is not possible in this second rotation direction. The relative rotation in the second rotation direction is prevented by clamping bodies 54. The ring gear 50 can be immobilized by means of a second coupling 56 which can be switched independently of the first coupling 53. To that end, in the exemplary embodiment shown, a pin 57 engages in a groove 58 in the ring gear 50. In the example shown, the second coupling 56 is locked in place by the pin 57. This is necessary, for example, if a start defined as a cold start is to be executed. A cold start control unit then provides for an immobilization of the ring gear 50 by means of the second coupling 56 (external requirement).

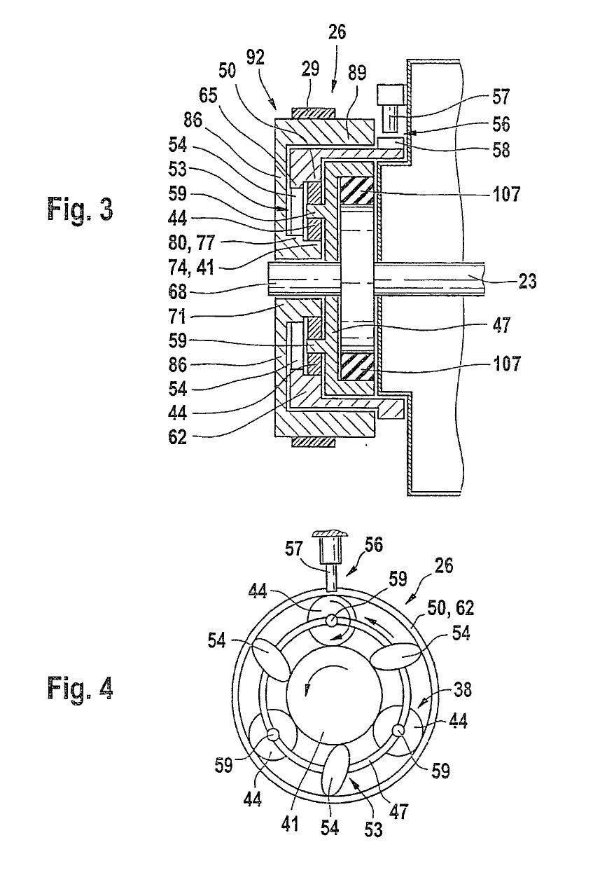

FIG. 3 shows a longitudinal section through the apparatus 26. For the sake of better comprehension, two clamping bodies 54 and two planet wheels 44 are respectively shown rotated into the plane of the drawing. The drive shaft 23 is non-rotatably connected to the planet support 47. The planet support 47 has three axial pins 59, see FIG. 2, which support the planet wheels 44 in rotary fashion. An intermediary ring 62 is embodied in such a way that on the one hand, it functions as a ring gear 50 and on the other hand, it functions as an outer ring 65 of the first coupling. The drive shaft 23 has a shaft journal 68 which supports a hub 71 in rotary fashion. The hub 71 has a first axial section 74, which functions as a sun wheel 41 for the planet wheels 44. A second axial section 77 of the hub 71 is used as an inner ring 80 of the first coupling 53. The first coupling 53 is comprised of the outer ring 65, the clamping bodies 54, and the inner ring 80. The hub 71 adjoins a disk-shaped region 86, which adjoins an essentially cylindrical section 89. The essentially cylindrical section 89, together with the disk-shaped region 86 and the hub 71, constitutes a wheel 92 that serves as a pulley for the belt 29. The wheel 92 is thus connected to a transmission part of the epicyclic gear 38. The intermediary ring 62 and therefore the ring gear 50 can be immobilized by the coupling 56 by means of the pin 57 and the groove 58. The coupling 56 is fastened to an outer part, the crankcase of the internal combustion engine.

If the intermediary ring 62, as shown in FIGS. 2 and 3, is not locked and if the wheel 92 and/or the sun wheel 41, as shown in FIG. 2, is rotated counterclockwise, i.e. in a first rotation direction, and if the drive shaft 23 is locked in place due to an external rotation resistance, then on the one hand, the first coupling 53 permits a relative rotation between the sun wheel 41 and the ring gear 50 and on the other hand, the ring gear 50 rotates. The planet support 47 does not rotate. The planet wheels 44 transmit the rotational movement of the sun wheel 43 to the ring gear. If the coupling 56 is disengaged, assuming the ideal situation, i.e. without acceleration and without friction, then no torque is exerted on the drive shaft 23. A slight and insignificant torque only occurs due to friction and acceleration of the rotating masses. With regard to FIG. 1, this means that the secondary assembly 32 operating as a motor uses the apparatus 26 and/or the wheel 92 as a deflection roller and only drives the air conditioning compressor 35, without causing the primary assembly 20 and/or the engine to be cranked. This arrangement and/or this positioning of the second coupling 56 is particularly useful when the primary assembly 20 is not operating, but an air conditioning compressor 35 needs to be driven nevertheless. This occurs when in energy-saving vehicles, which are equipped with such a primary assembly 20 and/or an arrangement according to FIG. 1, the engine is not being operated, but the passenger compartment should be air conditioned nevertheless.

The apparatus 26 shown in FIG. 4 is at this point immobilized by the second coupling 56, or its intermediary ring 62 and ring gear 50. In this case, if the wheel 92 is driven by the secondary assembly 32 operating as a motor, i.e. as a starter, then the sun wheel 41 drives the planet wheels 44 which roll along the immobilized ring gear 50. At the same time, the planet support 47 is moved in the first rotation direction. Since the planet support 47 is non-rotatably connected to the drive shaft 23, a torque is exerted on the drive shaft 23. If the primary assembly 20 is an internal combustion engine and the drive shaft 23 is a crankshaft, for example, then it is therefore possible for the engine to be cranked The first coupling 53 is disengaged in this instance. When the ring gear SO is immobilized, the epicyclic gear 38 produces a multiplication, which causes an increase in the torque, which is very advantageous for starting the internal combustion engine.

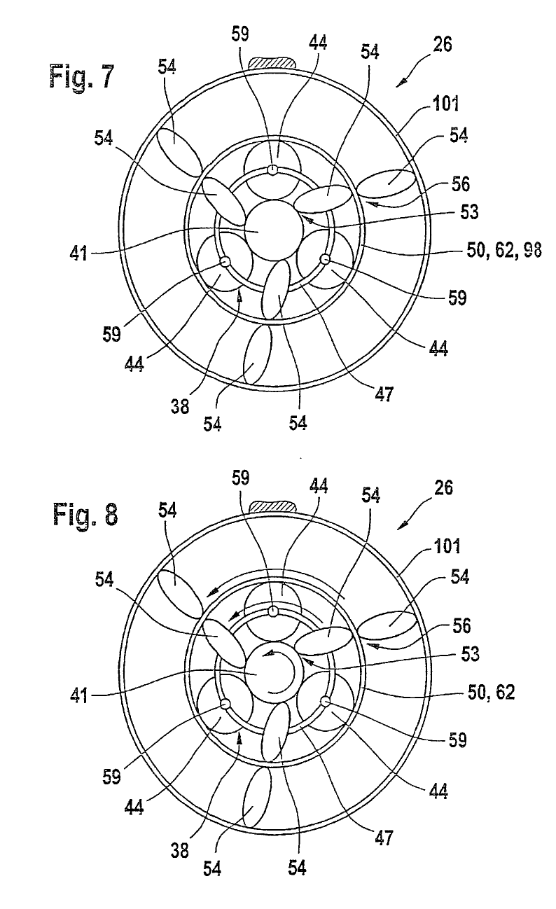

In this position, though, it is also possible for the internal combustion engine to drive the planet wheels 44 by means of the planet support 47 and therefore also to drive the sun wheel 41 and/or the wheel 92. As a result, by means of the first outer ring 65, which is immobilized by means of the coupling 56, a generator operation of the secondary assembly 32 is also possible. Here, too, the free-wheel 53 rotates; the high multiplication results in the fact that the wheel 92 rotates faster than the drive shaft 23. Therefore, even at low speeds of the internal combustion engine, the secondary assembly 32 can generate a high electrical output due to its inherent high speed. However, this only applies to an actively switchable coupling 56, not to a free wheel coupling 56, FIG. 7.

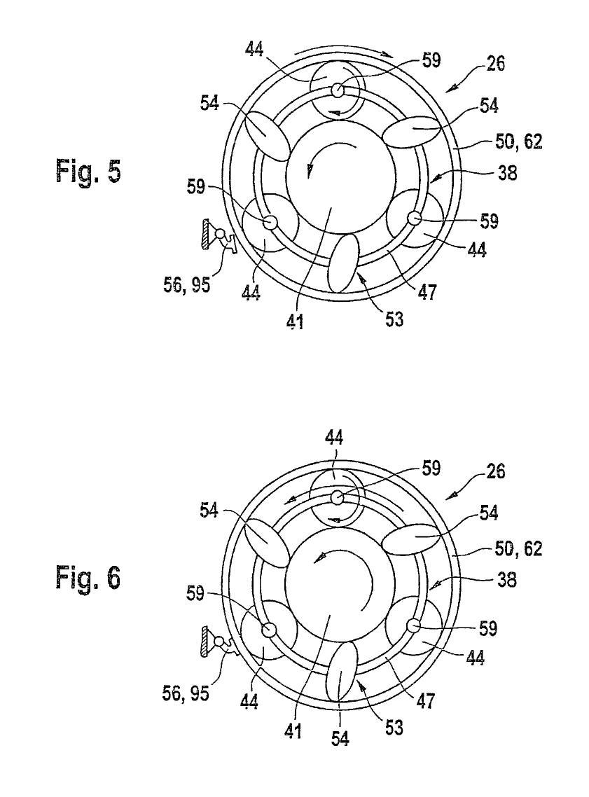

FIG. 5 shows the second exemplary embodiment. In this second exemplary embodiment, the second coupling 56 is a brake 95. If, as shown in FIG. 5, when the ring gear 50 and/or intermediary ring 62 is not braked, the wheel 92 is driven by the secondary assembly 32 operating as a motor, then an air conditioning compressor 35 can once again be operated while the internal combustion engine is switched off, also see FIG. 1. In this instance, the function is the same as that described in conjunction with FIG. 2. If the apparatus 26 is to be operated when the internal combustion engine is switched off, the secondary assembly 32 is operated as a motor, and the brake 95 is disengaged (engine-off air conditioning), then no torque that is usable for a starting procedure is transmitted to the drive shaft 23. Because of this external requirement, the brake remains disengaged. If the brake 35 is engaged because of an external requirement (desired start), i.e. if an increasing brake force is exerted on the intermediary ring 62, then the kinematic conditions change. The sun wheel 41, which is still rotating in the first rotation direction, produces not only a rotational movement of the planet wheels 44, but also a rotation of the planet support 47 in the first rotation direction when a brake force is acting on the intermediary ring 62 and therefore the ring gear 50 is being braked, FIG. 6. The stronger the braking action on the intermediary ring 62, the faster the planet support 47 then rotates in the first rotation direction. If the torque transmitted by the planet support 47 and the speed of the planet support 47 reach a minimal starting speed of the engine, then it is thus possible to crank the engine. The faster the brake 95 brings the ring gear 50 and/or the intermediary ring 62 to a stop, the better the motive energy of the secondary assembly 32 can be used for the starting procedure and/or for a momentum start of the internal combustion engine.

FIG. 7 is a schematic cross section through the third exemplary embodiment. Like the exemplary embodiments preceding it, this third exemplary embodiment has a sun wheel 41, planet wheels 44, a planet support 47, and a ring gear 50 and/or an intermediary ring 62. The first coupling 53 acts between the sun wheel 41 and the intermediary ring 62. The first coupling 53 once again prevents a rotation of the intermediary ring 62 in relation to the sun wheel 41 in the first rotation direction. In a modification in relation to the preceding exemplary embodiments, the intermediary ring 62 is an inner ring 98 of the second coupling 56. The second coupling 56 can likewise be switched independently of the first coupling 53. A second outer ring 101 is non-rotatably connected to an external part, here again the crankcase. The second coupling 56 is situated between the second outer ring 101 and the intermediary ring 62 in such a way that the intermediary ring 62 can be rotated in the first rotation direction in relation to the second outer ring 101. In a manner that corresponds to the first coupling 53, the clamping bodies 54 prevent a rotation of the inner ring 98 in the second rotation direction in relation to the second outer ring 101. With regard to an otherwise unchanged arrangement, also see FIG. 1, a generator operation occurs as follows:

The drive shaft 23, which is connected to the planet support 47, drives it in the first rotation direction, FIG. 8. Due to the moment- and force conditions in the first coupling 53, this first coupling 53 locks. This means that the sun wheel 41 rotates as a block together with the planet support 47 and the intermediary ring 62 and/or the first outer ring 65, i.e. the sun wheel 41 rotates at the same speed as the planet support 47. By contrast, the second coupling 56 permits a rotation of the second inner ring 98 and/or the intermediary ring 62 in the first rotation direction as a result of the kinematic conditions (internal requirement). The rotating sun wheel 41 causes the wheel 92 to move along with it and the secondary assembly 32 is therefore operated as a generator. The air conditioning compressor 35 is also operated by means of the traction mechanism 29. The speed ratio between the drive shaft 23 and/or crankshaft and the wheel 92 is 1 in this case.

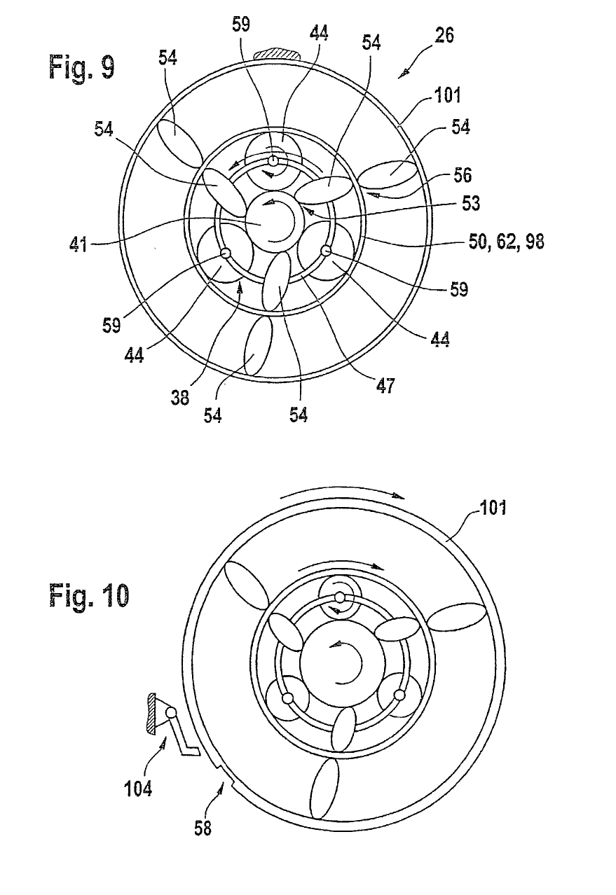

With the third exemplary embodiment, if a starter operation is provided, also see FIG. 9, then the sun wheel 41 is motor-driven in the first rotation direction by the secondary assembly 32. Due to the rotation resistance of the planet support 47, which is connected to the drive shaft 23 that continues rotating, after the initial breakaway torque of the primary assembly 20 and/or the internal combustion engine has been overcome, the planet support 47 rotates at a rotation speed that is reduced in relation to the sun wheel 41. Due to the force- and moment conditions, the first coupling 53 permits a rotation of the sun wheel 41 in the first rotation direction. By contrast, due to the kinematic conditions (internal requirement), the second coupling 56 locks in the second rotation direction, i.e. counter to the first rotation direction, so that the intermediary ring 62 is immobilized, also see FIG. 9.

The fourth exemplary embodiment, which is a modification of the third exemplary embodiment, differs from the third exemplary embodiment in that the second outer ring 101 is not initially immobilized in relation to its surroundings, i.e. in relation to the crankcase of the internal combustion engine, also see FIG. 10. On the contrary, the second outer ring 101 can, as an external part, be coupled to the stationary surroundings by means of a third coupling 104 embodied as a locking lever. In this fourth exemplary embodiment, if the secondary assembly 32 drives the wheel 92 while the primary assembly 20 and/or internal combustion engine is switched off, for example in the manner according to FIG. 1, then the air conditioning compressor 35 is operated when the third coupling is disengaged. The sun wheel 41, driven by the secondary assembly 32, thereby turns in the first rotation direction. The planet support 47, immobilized by the stationary drive shaft 23, likewise remains stationary. Due to the rotating planet wheels 44, the intermediary ring 62 turns in the second rotation direction, bringing along with it the second outer ring 101 by means of the locking second coupling 56. As a result, even when the primary assembly 20 is not driven and/or the drive shaft 23 is not rotating, it is possible to drive the air conditioning compressor 35.

If the third coupling 104, through engagement of the locking lever in the groove 58, immobilizes the second outer ring 101, then the same kinematic conditions exist as are described above in conjunction with the third exemplary embodiment.

In lieu of a third coupling 104 in the form of a locking lever, the fifth exemplary embodiment according to FIG. 11 has a third coupling 104 in the form of a brake. If the coupling 104 is disengaged, i.e. if it is exerting no braking moment on the second outer ring 101, then the same kinematic conditions exist as in the fourth exemplary embodiment when the locking lever is not engaged in the groove 58. According to the fifth exemplary embodiment, if the secondary assembly 32 drives the wheel 92 while the coupling 104 is initially disengaged, then the planet support 47 does not cause the drive shaft 23 to move along with it. By contrast, if the coupling 104 is placed with increasing force against the second outer ring 101, then the planet support 47, and therefore also the drive shaft 23, are increasingly accelerated when the second coupling is locked. As a result, the angular momentum of the secondary assembly 32 is also transmitted by the wheel 92 to the planet support 47 and thus to the drive shaft 23 and in this way, the drive shaft 23 is sped up sharply, i.e. undergoes very powerful angular acceleration, in order to crank the primary assembly 20 and/or the internal combustion engine.

In order to improve the apparatus 26, it is furthermore possible to introduce damping means 107 for vibration damping between the drive shaft 23 and the planet support 47, also see FIG. 3. With the damping means 107 as well, the connection between the drive shaft 23 and the planet support 47 is viewed as non-rotatable.

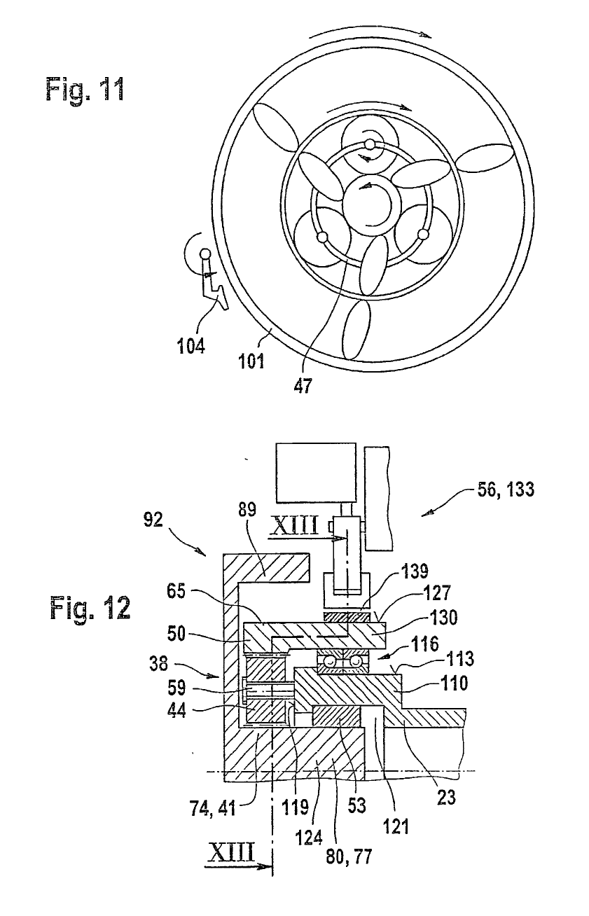

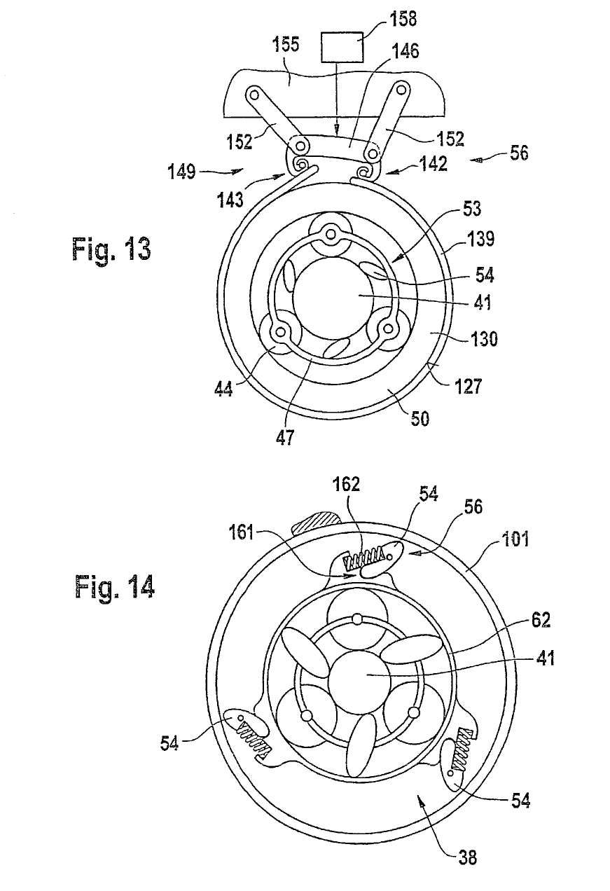

FIG. 12 shows a longitudinal section through a sixth exemplary embodiment. The drive shaft 23 of the primary assembly 20 has a cylindrically embodied drive shaft end 110 and a bearing 116 is situated against its cylindrical circumference 113. On its outer circumference, the bearing 16 supports the ring gear 50, which in this case constitutes an outer ring. The axial pins 59 for the planet wheels 44 are fastened in an end face of the drive shaft 23. By means of their gearing, the planet wheels 44 mesh with the gearing of the ring gear 50. A hollow cylindrical recess 121 contains the first coupling 53 in the form of a free-wheel coupling. Both the planet wheels 44 and the first coupling 53 cooperate with a shaft journal 124 of the wheel 92. To that end, the shaft journal 124 has the first axial section 74, which is embodied as a sun wheel 41 and cooperates with the planet wheels 44. The second axial section 77 cooperates as an inner ring 80 with the first coupling. The ring gear 50 has a cylindrical outside 127, which functions as a friction cylinder 130 for the second coupling 56, which is embodied as a friction clutch 133. The friction clutch 133 here is embodied as a friction belt brake whose friction belt 139 can be placed against the friction cylinder 130. In FIG. 12, for the sake of better comprehension, the friction belt 139 is depicted as rotated into the plane of the drawing in order to indicate its position against the friction cylinder 130. Necessary details of the second coupling are discussed in conjunction with FIG. 13.

The function of the second coupling 56 will be explained in detail in conjunction with FIG. 13. The depiction in this Fig. is limited solely to the friction cylinder 130 with the friction belt 139 and the second coupling 56. In contrast to its actual position in the apparatus 26, for the sake of comprehension, the first coupling 53 is depicted as though it were retracted into the foreground in order to clarify the interaction between the planet support 47 and the sun wheel 41. In principle, the friction clutch 133 is comprised of the friction belt 139, which is connected via two links 142 and 143 to a first member 146 of a four-bar chain 149. In addition to the first member 146, the four-bar chain 149 has two second members 152, which are rotatably fastened to a third stationary member 155. In addition, the second coupling 56 has an actuator 158 whose purpose is to force the first member 146 to change position. The actuator 158 executes the position change of the first member by means of an element that is not shown.

If a primary assembly 20 embodied as an internal combustion engine is to be started by means of the secondary assembly 32 embodied as a starter generator (external requirement), then the secondary assembly 32 drives the sun wheel 41 in the first rotation direction (counterclockwise) by means of the transmission mechanism 27. The drive shaft 23 and therefore also the planet support 47 do not rotate at first. The friction clutch 133 and therefore the first member 146 are set so that it is not possible for the ring gear 50 to rotate in the second rotation direction (clockwise). Due to the kinematic conditions in the epicyclic gear 38, causes the sun wheel 41 to drive the planet wheels 44 supported against the ring gear 50, as a result of which the planet support 47 executes a rotation in the first rotation direction. By means of the freely rotating planet support 47, the crankshaft and/or drive shaft 23 begins to rotate, which causes the internal combustion engine and/or the primary assembly 20 to be cranked. The free-wheel coupling and/or the first coupling 53 permits a relative rotation here between the sun wheel 41 and the planet support 47. This results in the setting of an angular velocity of the planet support 47 that is reduced by approximately one third in comparison to the angular velocity of the wheel 92. The torque acting on the drive shaft 23 is thus increased approximately threefold.

If the primary assembly 20 and/or the internal combustion engine starts to run by itself, then it produces a force direction change between the planet wheels 44 and the ring gear 50 by means of the drive shaft 23 and the planet support 47 connected to this shaft, so that the friction belt 139 lifts up from the friction cylinder 130 in such a way that there is no more braking action. At the same time, the planet support 47 and/or drive shaft end 110—by means of its cylindrical inner surface, the first coupling 53, and the second axial section 77—drives the sun wheel 41 to rotate along with it and therefore, by means of the wheel 92 and/or its cylindrical section 89, ends up driving the secondary assembly 32 and therefore the starter generator so that this starter generator can be operated as a generator. In this case, the second coupling is open.

At low speeds of the internal combustion engine and/or the primary assembly 20, it can be useful to increase the current output of the secondary assembly 32 embodied as a starter generator. To that end, this arrangement makes it possible, through a simple switching of the first member 46 by means of the actuator 158 and thereby a shifting of the first member 146 toward the left, to engage the second coupling 56 once more. As a result, when driven by the drive shaft 23 and/or the planet support 47, the ring gear 50 is locked so that the planet wheels 47 drive the sun wheel 41 with an increased angular velocity (approx. threefold). As a secondary assembly 32, the starter generator is thereby operated at an increased speed by means of the wheel 92 and the transmission mechanism 27 so that this starter generator is in a position to produce more power when operating as a generator.

If the speed of the engine increases, then the secondary assembly 32 and/or the starter generator must not be overloaded when operating with the high multiplication stage. The high multiplication stage would theoretically make it possible to compel a rotor of the starter generator to operate at such high speeds that it would be destroyed by the stress of centrifugal force. This must be prevented. In this connection, a prompt switch must be made from the high multiplication stage to the low multiplication stage. In terms of kinematics, the actuator 158 is not in a position to do this; this is only possible by means of a torque change in the sun wheel 41. This means that before being switched from the high multiplication stage to the low multiplication stage, the starter generator must be temporarily operated as a motor to impart a torque change to the ring gear 50 by means of the planet wheels 44 in order to permit a detachment of the friction belt 139 and at the same time, to permit the actuator 158 to bring the first member 146 temporarily into a neutral position. In order to then finally reach a low multiplication, the first member 146 must be tilted into the position shown in FIG. 13 during the temporary motor operation of the secondary assembly 32. Then with a simultaneous driving action of the secondary assembly 32, the friction belt 139 brings the ring gear 50 to a stop. If this switching procedure is initiated and a reliable engagement of the second coupling 56 is possible, then the secondary assembly 32 can be switched back into generator operation. After the second coupling 56 is engaged, the secondary assembly 32 is then driven with the low multiplication.

If a vehicle is equipped with a so-called “start and stop automation”, then it is possible for this apparatus to also achieve a so-called at-rest air conditioning, as has already been described in conjunction with the preceding examples. When the engine is switched off and the friction clutch 133 and/or the second coupling 56 is disengaged, the secondary assembly 32 drives an air conditioning compressor which is also belt-driven, for example, as a result of which the at-rest air conditioning is achieved. In this connection, the ring gear 50 rotates freely. With the aid of the apparatus according to FIGS. 12 and 13, it is also possible to execute a so-called momentum start of an internal combustion engine. To this end, the secondary assembly 32 is used as a drive mechanism in the same manner as before. The friction clutch in this instance is initially disengaged and the friction belt 139 is not in contact. The sun wheel 41 is driven by the secondary assembly 32, the ring gear 50 is set into rotation (second rotation direction) by the stationary planet support 47. The secondary assembly 32 angularly accelerates up to suitably high speeds so that the entire drive train between the secondary assembly 32 and the ring gear 50 has enough kinetic energy in order, when the friction clutch 133 is engaged, to crank the engine by means of the torque finally acting on the planet support 47. The first member 146 thereby assumes the position shown in FIG. 13, i.e. a position shifted slightly to the right 5

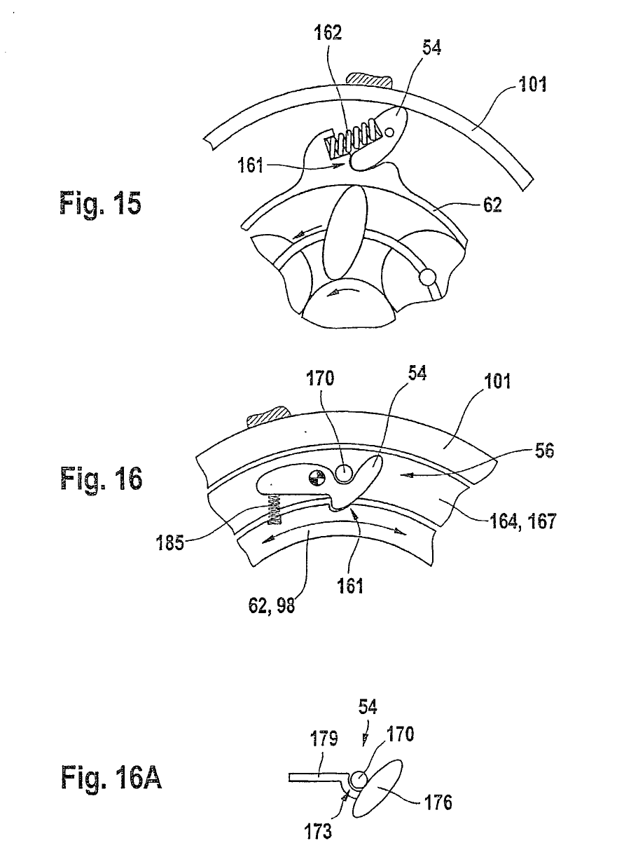

FIG. 14 shows another exemplary embodiment. This exemplary embodiment represents a variant based on the exemplary embodiment according to FIG. 7. While the second coupling 56 from FIG. 7 is independent of the angular acceleration of the intermediary ring 62, the second coupling 56 in the exemplary embodiment according to FIG. 14 is locked as a function of the angular acceleration of the intermediary ring 62. For this purpose, the ends of the clamping bodies 54 that are directed radially inward are supported in a cavity 161 in which the clamping bodies 54 can be moved in a pivoting fashion. Alternatively, the clamping bodies 54 could also be supported in a pivoting fashion by means of a hinged bearing between the clamping body 54 and the intermediary ring 62. A compression spring 162 supported on the intermediary ring 62 thereby produces an initial position of the clamping body 54, which has no contact with the second outer ring 101 in this position. If the secondary assembly 32, which is operated as a motor, now introduces a driving moment into the epicyclic gear 38 via the sun wheel 41 in order to start the engine and/or the primary assembly 20, then the ring gear is moved with a high angular acceleration. Because of its inherent inertia of masses, the clamping body 54 follows in a limited fashion, is thus moved into a raised position, and finally is brought into the locked position, see FIG. 15. The ring gear 50 and/or the intermediary ring 62 are thus locked in place. The epicyclic gear 38 then transmits the torque of the secondary assembly 32 to the drive shaft 23 so that the primary assembly 20 is started with the multiplication of the epicyclic gear and therefore with a large amount of torque. The second coupling 56 (inertia switchable free-wheel), with this property, permits an overtaking of the drive shaft 23 of the kind that customarily occurs during the starting process of an internal combustion engine. After such an overtaking of the drive shaft 23, the drive shaft 23 decelerates again with a high angular acceleration so that the second coupling 56 is brought back into the locked position.

With the generator operation of the secondary assembly 32, the moment conditions in the epicyclic gear 38 are reversed. The second coupling 56 does not lock and the ring gear 50 can rotate freely. In this state, the epicyclic gear 38 does not transmit any torque. The speed of the sun wheel 41 therefore decreases until it has reached the speed of the drive shaft 23. If this is the case, then the first coupling 53 engages.

Additional secondary assemblies, e.g. the air conditioning compressor 35, are driven by means of the transmission mechanism 27. If the air conditioning compressor 35 is driven by the secondary assembly 32 without transmitting a driving moment to the drive shaft 23, then only a slight torque is generated at first by the secondary assembly 32. The epicyclic gear 38 only starts to move slowly so that the ring gear 50 and/or the intermediary ring 62 undergoes only a slight angular acceleration. The spring 162 holds the clamping bodies 54 in their rest position and the second coupling 54 does not lock.

FIG. 16 shows a partial section through another exemplary embodiment based on the exemplary embodiment according to FIG. 7. As opposed to the exemplary embodiment according to FIG. 7, the second coupling 56 is replaced by the second coupling 56 shown in FIG. 16. The intermediary ring 62 and/or second inner ring 98 is replaced by a second inner ring 98, which has at least one cavity 161 on its cylindrical outer circumference into which a clamping body 54 can be inserted. A cage 164, which is embodied in an annular shape, is disposed between the inner ring 98 and the outer ring 101. The cage 164 has an end face 167 that has small bolts 170 extending from it in the axial direction. These bolts 170 synchronize the movement of the clamping bodies 54. After assembly, the bolt 170 is disposed in a cavity-like recess 173 of the clamping body 54, also see FIG. 16A. The clamping body 54 is comprised on the one hand of the actual clamping part 176, which is disposed on one side of the bolt 170, and a lever part 179, which has the cavity-like recess 173. The lever part 179 is disposed on the other side of the bolt 170 so that the clamping part 176 and the lever part 179 are approximately disposed diametrically opposite from each other. The center of gravity of the clamping body 54 here is disposed to the left of the cavity 161. A compression spring 185 is supported against the lever part 179. If the inner ring 98 is rotated in the first rotation direction (clockwise), then the clamping body 54 is in fact rotated slightly clockwise in the cavity 161, but the clamping body 54 does not lock the second coupling 56; the inner ring 98 can thus rotate freely.|

If the inner ring 98 rotates in the second rotation direction—at a constant rotation speed—then the second coupling 56 is likewise not locked. If the inner ring 98 is moved with a large angular acceleration in the second rotation direction (counterclockwise), then the clamping part 176 is rotated in the cavity 161 so that the coupling 56 finally locks. This is the case at low rotation speeds. If the rotation speed is very high, then the centrifugal force of the clamping body 54 prevents the second coupling 56 from locking despite the angular acceleration in the second rotation direction. Thus during rotation of the inner ring 98, the mass of the lever part 179 prevents the locking action of the clamping body 54. In the secondary assembly 32, in the operation 27, in the apparatus 26, and in the primary assembly, a preventive measure can be provided so that with an electrical secondary assembly 32, when a moment collision occurs, the drive stops the rotating ring gear 50 and the primary assembly 20 is started. Otherwise, the cage 164 serves to synchronize the movement of the clamping bodies 54 and thus to evenly distribute the load to all of the clamping bodies 54.

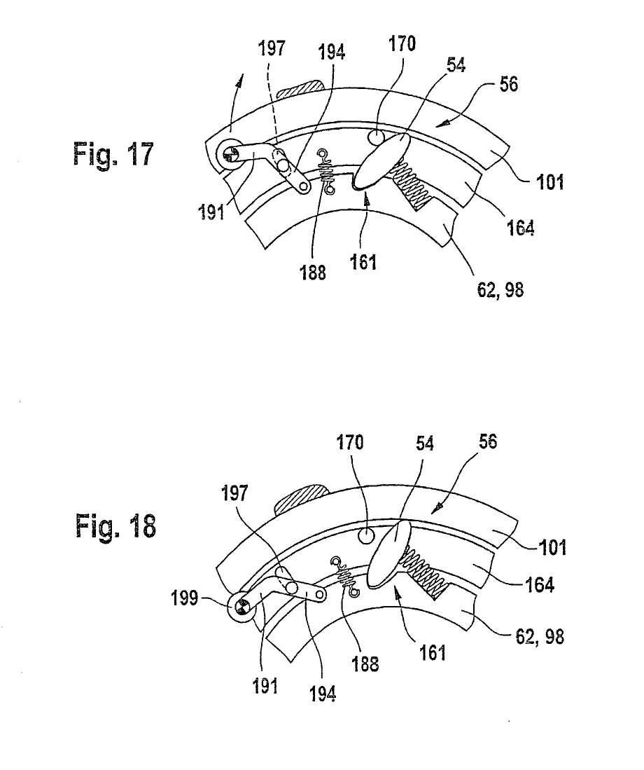

FIG. 17 shows another variant of the second coupling 56. Once again, clamping bodies 54 are disposed between the inner ring 98 and the outer ring 101. In the initial rest position shown in FIG. 17, a bistable spring 188 assures that the cage 164 with the bolts 170 is turned slightly and thus the bolts 170 are pressed against the clamping bodies 54 so that the clamping bodies 54 do not rest against the outer ring 101 and so no clamping action occurs. If a rapid angular acceleration of the inner ring 98 now occurs in the second rotation direction, then the one position of the bistable spring 188 is overcome so that the cage 164 is shifted in relation to the inner ring 98 in the first rotation direction so that the bolts 170 release the clamping bodies 54 and as a result, the second coupling 56 locks once more. A lever 191 is linked to the inner ring 98 at one end; the lever 191 can slide with a middle bolt part 194 in a groove 197 that extends radially toward the outside in the cage. If an intense angular acceleration of the inner ring 98 in the second rotation direction now occurs, then the one designated position of the bistable spring 188 is set, the clamping bodies 54 move in the second rotation direction in relation to the bolts 170 and come into contact with the outer ring 101, also see FIG. 18. At the same time, the bistable spring 188 changes position and assumes a second position that defines the relative position of the cage 164 to the inner ring 98. The lever 191 moves or rotates simultaneously in the first rotation direction around the linkage point on the inner ring 98 and the bolt part 194 thereby simultaneously slides radially inward in the groove 197. If the inner part 98 is moved again in the free-wheeling direction, i.e. in the first rotation direction, then the centrifugal force of a mass 199 on the lever 191 causes the cage 164 and its bolts 170 to be pressed against the clamping bodies 54 once more and as a result, these clamping bodies 54 are moved back into their raised starting position.

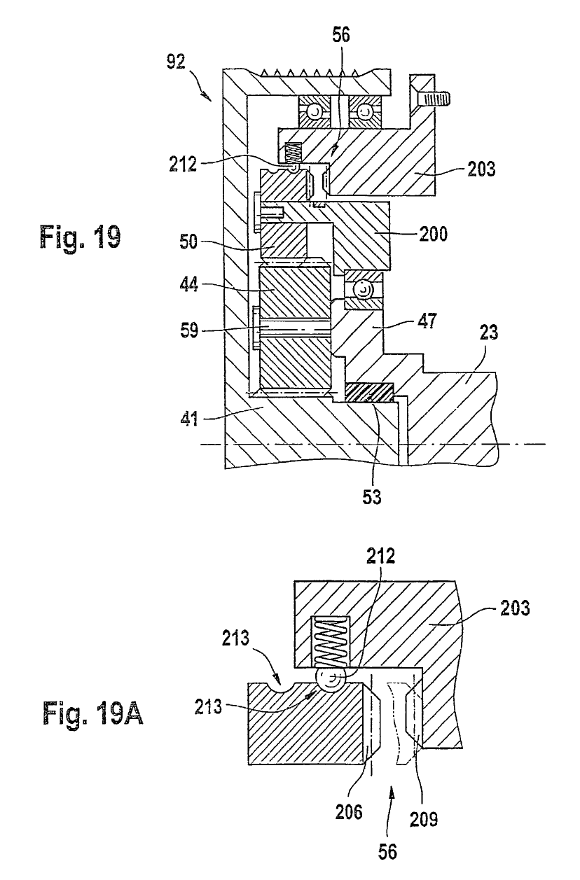

FIG. 19 shows a final exemplary embodiment. This apparatus 26 also has a planet support 47 that is connected to the drive shaft 23 and has planet wheels 44 disposed on its axial pins 59. Here, too, the planet wheels 44 mesh with a ring gear 50 that is disposed so that it can move axially on a ring gear support 200. The ring gear 50 can thereby assume two different positions: on the one hand, the one depicted in FIG. 19 and on the other hand, a position in which it is shifted to the right, as indicated in FIG. 19A; in the position that is shifted to the right, a second coupling 56 is active. The second coupling 56 here operates between the ring gear 50 and a stationary part 203. The second coupling 56 is comprised of a first form-fitting element 206 and a second form-fitting element 209 on the stationary part 203. The epicyclic gear 38 in this case has a helical gearing so that a transmitted torque produces an axial force. The switching of the position of the ring gear 50 thus takes place via the torque that is transmitted by the epicyclic gear 38. A spring-loaded detent element 212 permits fixed torque thresholds for the switching to be set. The thresholds depend on the power of the spring and the geometric proportions of a groove 213 into which the detent element 212 is pressed. The switching thresholds for the connection and disconnection of the locking of the second coupling 56 can therefore be set independently of each other.

A locking of the second coupling 56 is achieved by virtue of the fact that an acceleration of the wheel 92 via the epicyclic gear 38 is converted into an acceleration of the ring gear 50 and the ring gear support 200. The transmission torque is determined according to the law of angular momentum and by means of the angular acceleration and the inertia of the ring gear 50 and the ring gear support 200. If this torque exceeds an established threshold, the ring gear 50 is brought into the locked position. This event is triggered when the internal combustion engine and/or the primary assembly 20 is started.

The second coupling 56 is disengaged by virtue of the fact that a negative torque is imparted by the wheel 92, which is encouraged by the locked ring gear 50. If this torque exceeds an established threshold, the ring gear 50 is shifted into the disengaged position. This event is triggered, for example, when the secondary assembly 32 is switched into generator operation.

A suitable triggering of the secondary assembly 32 makes it possible, for example, to arbitrarily control the position of the ring gear 50. The multiplication of the epicyclic gear 38 can thus be arbitrarily connected and disconnected. At low motor speeds, the secondary assembly 32 can be set to the higher multiplication stage, which makes it possible for there to be higher outputs of the secondary assembly 32.

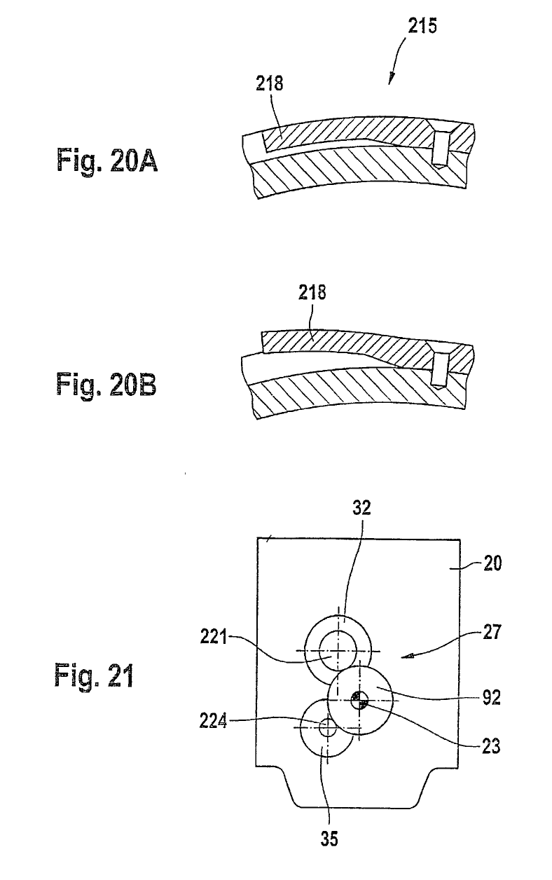

FIG. 20A is an axial view of a locking device. This locking device is disposed on the outer circumference of the ring gear support 200 between the ring gear 50 and the stationary part 203, between the two form-fitting elements 206 and 209. This locking device 215 includes a leaf spring part 218. At speeds that exceed an established threshold, the leaf spring part 218 is bent outward by the centrifugal force, see FIG. 20B, and thus locks the axial position of the ring gear 50 in place. The speed threshold itself can be set by means of the initial tension of the leaf spring 218.

The starter generator 32, the apparatus 26, and the air conditioning compressor 35 are connected to one another by means of a traction mechanism 29. Both a belt and a chain are suitable for use as the traction mechanism 29.

Instead of a traction-driven transmission mechanism, which connects the starter generator 32, the apparatus 26, and the air conditioning compressor 35 by means of the traction mechanism 29, a set of gears call also be used.

In the exemplary embodiment according to FIG. 21, the starter generator 32 engages the wheel 92, which is embodied as a gear, by means of a gear 110. The air conditioning compressor 35 is non-rotatably connected to a gear 113 and engages with the wheel 92. Depending on the desired multiplication and/or the desired engagement, in another arrangement that is not shown, the wheel 110 can engage the wheel 92 indirectly by means of the gear 113. As another alternative, it is possible to place the gear 110 between the gear 113 and the wheel 92.

1. An apparatus for coupling at least one secondary assembly (32), in particular a starter generator, to a primary assembly (20), in particular an internal combustion engine, where the at least one secondary assembly (32) and the apparatus for coupling (26) are connected to each other by means of a transmission mechanism (27), having an epicyclic gear (38) which connects the primary assembly (20) to the transmission mechanism (27), where the epicyclic gear (38) can be switched between two multiplications by means of a first coupling (53), characterized in that the first coupling (53) is a free-wheel coupling and that a ring gear (50) of the epicyclic gear (38) can be inmobilized in at least one rotation direction by means of a second coupling (56).

2. The apparatus according to claim 1, characterized in that a planet support (47) is non-rotatably connected to a drive shaft (23) of the primary assembly (20), in particular a crankshaft of the internal combustion engine, and that a torque can be transmitted by means of a sun wheel (41) between the transmission mechanism (27) and the epicyclic gear (38).

3. The apparatus according to one of the preceding claims, characterized in that the first coupling (53) permits a relative rotation of the sun wheel (41) in relation to the ring gear (50) in a first rotation direction and prevents it in a second rotation direction.

4. The apparatus according to one of the preceding claims, characterized in that between the ring gear (50) and an outer part, there is a second coupling (56) which, as a free-wheel, permits the ring gear (50) to rotate at least in the first rotation direction.

5. The apparatus according to one of the preceding claims, characterized in that under certain conditions, the second coupling (56) permits the ring gear (50) to rotate in the second rotation direction.

6. The apparatus according to one of the preceding claims, characterized in that depending on external requirements, the second coupling (56) either can be set to function as a free-wheel in the one or the other rotation direction or can be set to function as a no-load mechanism.

7. The apparatus according to one of claims 1 to 5, characterized in that the second coupling (56) that is embodied as a free-wheel releases or locks the ring gear (50) as a function of an internal requirement.

8. The apparatus according to claim 7, characterized in that the internal requirement is an angular acceleration or the rotation speed of the ring gear (50).

9. The apparatus according to one of claims 4 to 9, characterized in that above a threshold of the internal requirement, it is not possible for the ring gear (50) to be coupled.

10. The apparatus according to one of the preceding claims, characterized in that the outer part is a second outer ring (101) which can be coupled to a stationary part by means of a third coupling (104).

11. The apparatus according to one of the preceding claims, characterized in that at least one rotating outer ring (65, 101) can be braked by means of a brake.

12. The apparatus according to one of the preceding claims, characterized in that the secondary assembly (32) can be driven without an opposing moment of the primary assembly (20).
